(19) United States
(12) Patent Application Publication
(10) Pub. No.: US 2011/0061357 A1
(43) Pub. Date: Mar. 17, 2011

(54) VERSATILE LEAF DREDGING TOOL FOR SWIMMING POOLS

(76) Inventor: Francis M. Rathjen, Great Falls, VA (US)

(21) Appl. No.: 12/763,042

(22) Filed: Apr. 19, 2010

Related U.S. Application Data
(60) Provisional application No. 61/170,625, filed on Apr. 19, 2009.

(51) Int. Cl. A01D 7/00

(52) U.S. Cl. 56/400.01

(57) ABSTRACT

The invention is a versatile plastic-molded pool cover dredging tool having first portion of a solid uniplanar support panel connected to a second semi-cylindrical portion. The semi-cylindrical portion include a set of fingers extending from a solid horizontal portion formed perpendicular to the uniplanar support panel. The set of fingers extends downward in a first cylindrical arc, the set of fingers being connected at a second horizontal portion, then the set of fingers extending upward in the first cylindrical arc. The tool also includes two end structures located at each end, extending downward from the support panel in a second cylindrical arc. The tool may be attached to any type of pool pole and be used in other home and gardening purposes.

This application claims priority under 35 USC 119(e) to U.S. Provisional Application Ser. No. 61/170,625, filed Apr. 19, 2010, which is incorporated by reference for all purposes.

### INTRODUCTION

Currently, there is no available instrument or tool which has the ease of use in removing matter from pools or water without considerable effort. In removing wet submerged matter, such as leaves, from a pool cover the methods include removal of the pool cover which required draining and pumping the water off the surface of the pool cover, or the use of a much bulkier tool (or poor adapted for the use). There is a product for this particular use call the “Leaf Net,” which is put over the pool and weighted down with water tubes or other weighting implements around the perimeter of the pool. The Leaf Net covers the pool and captures the leaves over the non-use months.

### SUMMARY OF THE INVENTION

One of the primary embodiments of the present invention is a surface dredging tool which can be attachable to various extenders in varying lengths. The lightweight tool may be used in various manners is convenient for removing lightweight material such as submerged leaves from the tops of pool covers after winter, shallow man-made ponds, and other places similar to fountain basis, reflection pools or places where the use of this tool is foreseeable. There are other tools or attachments for a pool extension rod handle.

The surface dredging tool is designed with reinforced non-flexible fork-like prongs or fingers that allow the tool to be dragged through the water and easily capture leaves, but allow water to drain through. The semi-cylindrical shape of the surface dredging tool is partially captured at both ends. A primary embodiment of the invention implements knobs at the end of each finger to prevent scratching. In a primary embodiment, the tool is made of molded lightweight inflexible plastic, allowing for a reduced retail footprint as well.

Features of some of the embodiments include: Curved crescentine forks design for easy grabbing and drainage. A Lightweight molded ABS plastic structure provides strong durable easy manipulation. Rounded end design won't puncture pool covers. Butterfly clip-on part works with common pool poles. Tine spacing Enhances quick drainage. Solid structure versus mesh net provide anti-foul for small twigs and sticks. The curved tine design helps eliminate vertical raking.

### BRIEF REFERENCE TO THE DRAWINGS

Reference is made to the accompanying drawings, in which:

FIG. 1A illustrates a frontal view of the surface dredging tool in a first embodiment;

FIG. 1B illustrates a top angle view of the surface dredging tool in a first embodiment;

FIG. 1C is a side view of the surface dredging tool;

FIG. 1D is a “bottom view” of the surface dredging tool;

FIG. 2 is a first detail view of the surface dredging tool in a first embodiment;

FIG. 3 is a detailed view of the attachment mechanism in a first embodiment;

FIG. 4 is sample marketing box of the present invention; and

FIG. 5 is an alternate display mechanism in an alternate embodiment;

FIG. 6A is a first view of a generic embodiment of the invention; and

FIG. 6B is second view of a generic embodiment of the invention;

FIG. 7 is a full crescent fork embodiment of the invention;

FIG. 8 is a semi-crescent fork embodiment of the invention;

FIG. 9 is a square fork embodiment of the invention;

FIGS. 10A-F illustrate various alternate uses of the versatile rake.

### DETAILED DESCRIPTION OF THE INVENTION

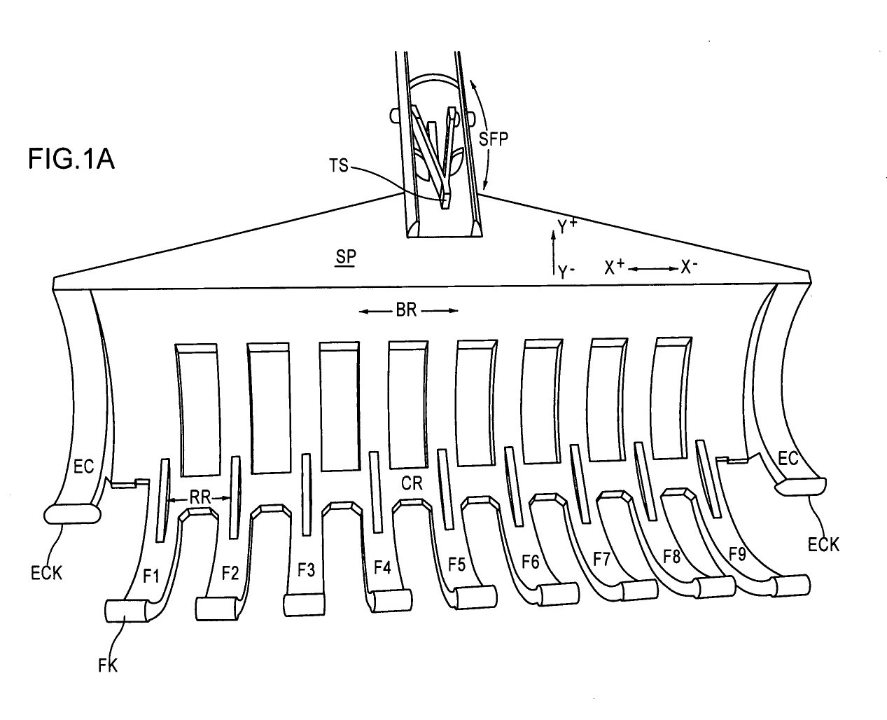

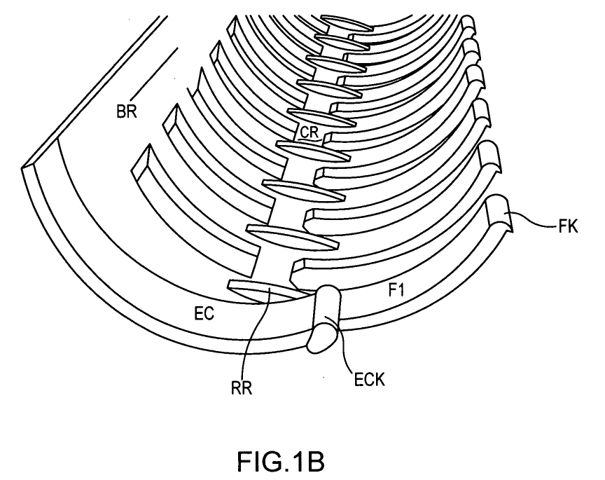

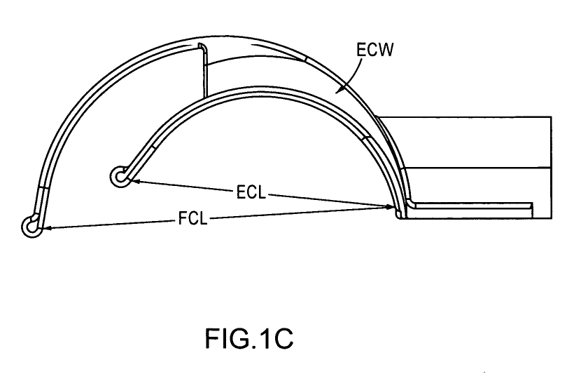

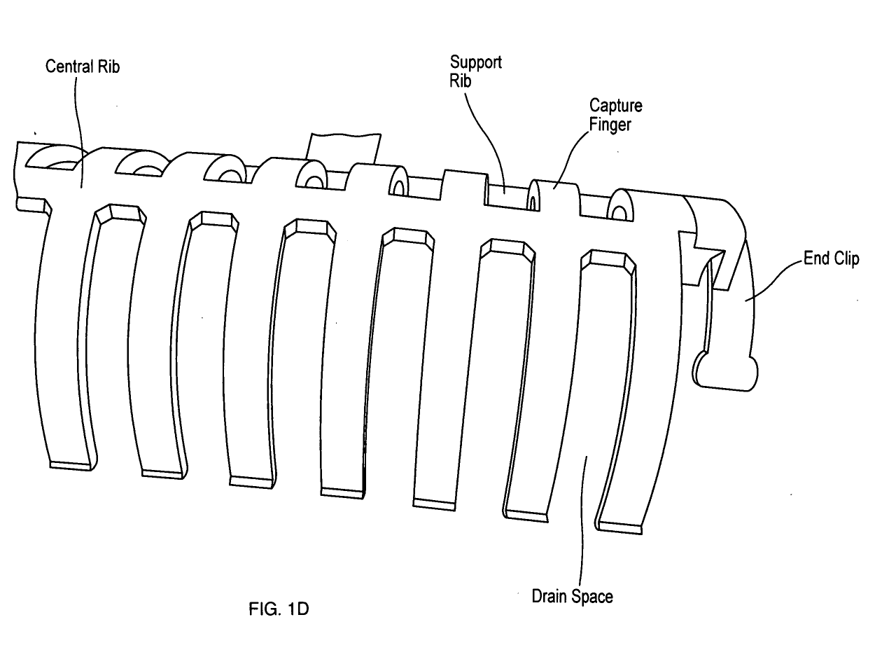

Referring now to FIG. 1A, a first embodiment of the invention is shown from a top view. In a preferred embodiment, the surface dredging tool SDT is made of an inflexible molded plastic for efficient and inexpensive manufacturing. The tool SDT is preferably made of a single piece of material, and, in a preferred embodiment is a molded piece of inflexible (and lightweight) plastic, and includes a triangular stability plate SP which is connected at the top to a connector tube CT and a connector C, which is generally connected to an extension rod R. The body of the of the removal tool extends in a semi-circular arc perpendicular to the stability plate SP in the negative z direction (bottom) that begins with the back rib BR structure. The back rib structure extends in a downward arc cylinder and supports the fingers F1-F9 that extend in a cylindrical arc from the back rib BR. Leaving finger spaces FS1-FS8 in between each finger, which allows the water to drain.

Each of the fingers F1-F9 extends “outward” in a cylindrical arc, first the upper portion of the finder extends in a “downward” arc, meet a horizontal (moving along x− to x+) central supporting rib CR which supports the fingers (in contrast to a third embodiment). At approximately the central supporting rib CR, the fingers F1-F9, move in an upward cylindrical arc (towards the z+ plane) ending in an optional “knob” KN1 at the end of each finger F1-F9. The optional knob allows each finger to help keep the material to be dredged on the tool. The knobs are also rounded and smooth so that they not only assist in keeping the material on the tool, but also so that the ends of the fingers do not scratch the pool cover or other delicate material.

Also referring to FIG. 1A, and located at the x+ and x− “ends” of the rake, and extending downward from the back rib BR are the end clips EC. The end clips EC curve in at a tighter cylindrical arc, or a smaller crescent, than the fingers F1-F9 in a preferred embodiment, which creates a “pocket” within the cylindrical arc allowing the rake to remove matter without it slipping out “over” the ends. The end clips EC are supported by an end support ES which extends downward from the back rib BR. Also shown in FIG. 1A (and discussed in detail later on) are the reinforcement ribs RR which are included on the central supporting rib CR in the middle of each finger F1-F9.

Referring now to FIG. 1B, a top viewed angle of the first embodiment of the dredge tool is shown. The end clips EC are shown extending in a tighter arc or smaller crescent than the fingers F1-F9, so that the dredge tool may be tilted or rotated from side to side without spilling the dredged matter. Also shown is the configuration of the reinforcement ribs RR located on each finger, which in the shown embodiment is a small arch extending further onto each finger in the “outward” direction, providing more support for the load heavy dredged material on the extended or lower finger.

Referring now to FIG. 1C a side view of the first embodiment of the dredging tool is shown. As can be seen from the illustration the diameter FCL of the semi-cylinder or crescent of the fingers F1-F9 extending from the back wall is larger that the diameter of the semi-cylinder formed ECL from the end clips EC, creating a “pocket” in cylinder to help carry the dredged matter. Also shown in FIG. 1C is a support wall for the end clips ECW which help to support heavy dredge matter. In general, as shown, in the preferred embodiments, the dredging tool is made of a molded inflexible plastic.

Referring now to FIG. 1D, we see the reverse or underside of the dredging tool. In a preferred embodiment, the molded plastic is smooth and the mold is designed for a balance between weight and strength. Other “patterns” may also be implemented in various embodiments, mainly through plastic molding, which provide various advantages, such as strength and/or a reduction in material. Patterns may include a “waffle” pattern, a zig-zag pattern, etcetera either on the surface or along the circumference of the cut-out spaces.

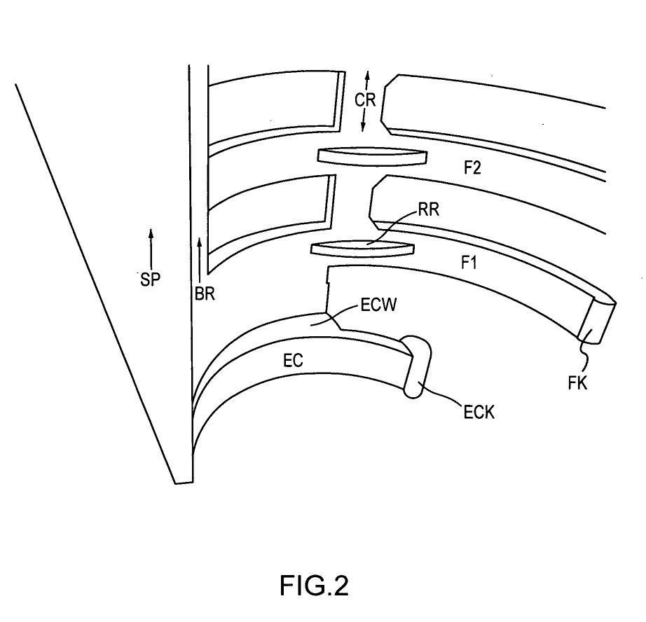

Referring now to FIG. 2 a detail of one side portion of the dredging tool. The elements are generally the same as described above in FIGS. 1A-1C, in closer detail. Note that some of the physical structures appear to have “molding marks” on them. However, these are not usually intended for any structural purposes and may be removed for retail.

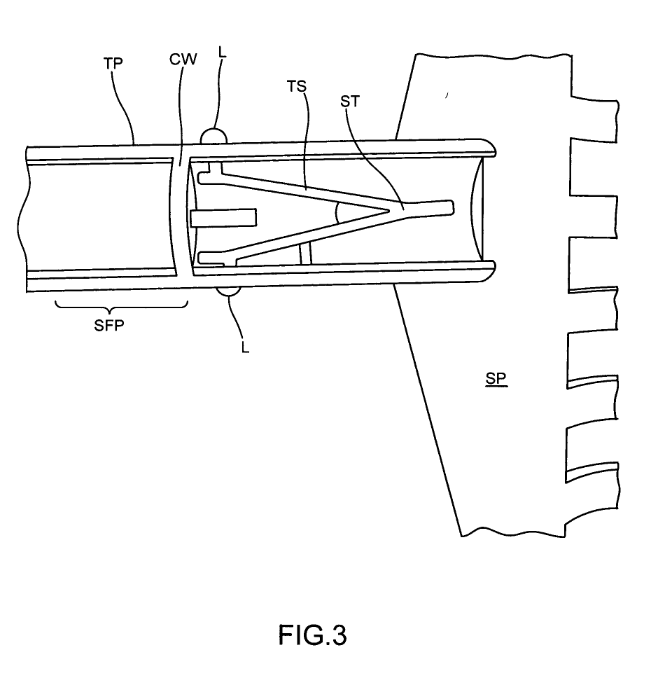

Referring now to FIG. 3, the detail of a sample snap-fit portion of the dredge tool (marketed as a “quick connect push snap”). The snap fit portion SFP is molded to the body of the dredging tool in a preferred embodiment. The snap fit portion can be customized to fit into any “hollow” rod with a pin hole, but in the preferred embodiment is fit into a lightweight, inflexible rod. The hollow part of the rod (not shown) slides over the tubular portion TP. A couple of holes in the hollow rod (not shown) slide all the way to the two pins L until the pins L catch into the two holes, stabilizing and locking the dredge tool onto the rod. The two pins L are supported and held in tension from a (outward tensioning) forkspring which acts as the tension support keeping the pins L in place and is attached at the upper end by the a circular wall molded into the hollow space inside the snap fit portion SFP about halfway up. In general, the pins L and tensioning forkspring TS are assembled separately after the molding of the main body of dredging tool. The rod may be removed easily from the dredging tool by pressing on the pins L and releasing the lock. Thus, although it is not shown, it is considered that other types of useful tools are easily swapped with the dredging tool, snap fitting on the rod. It is also considered that rods of different lengths will be used with the dredging tool increasing its usefulness and flexibility.

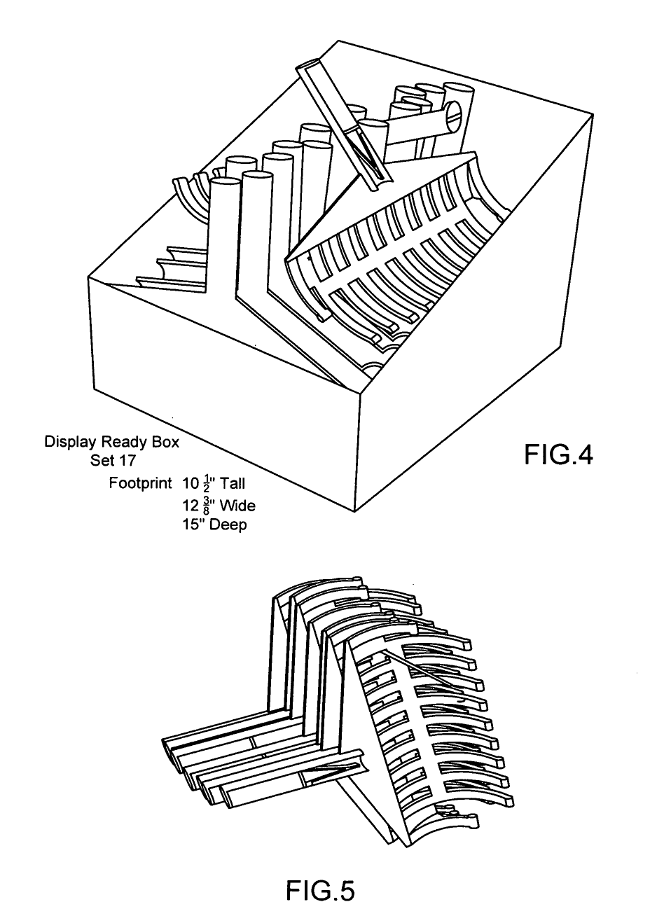

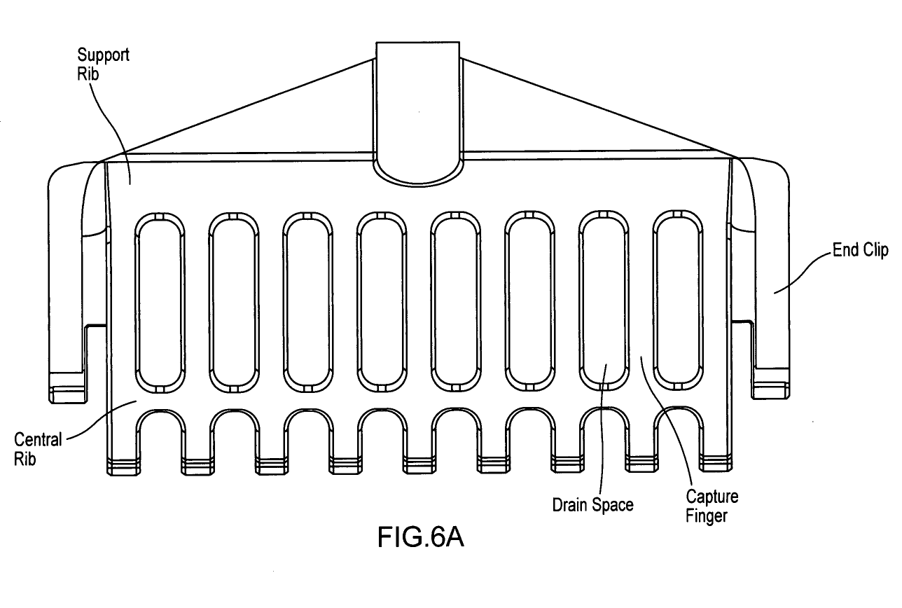

Other inventive advantage of particular embodiments of the invention are shown in FIGS. 4 and 5. These advantage are provided by the reduction in retail space footprint, allowing the preferred embodiment of the present invention to be sold in an efficient manner. One of the features is show in FIG. 4 where the dredging tools are packed efficient in a box. The partially-cylindrical shape of the tool allows them to be packed together without much space. Furthermore, a customer can remove a single unit without disrupting the whole box. Other advantageous display is shown in FIG. 5 in which the leaf dredging tools LDT are stacked on a single peg, reducing the retail footprint. Once again, the partially cylindrical shape allows the parts to stack efficiently.

In other embodiments the dredging tool can be manufactured using such materials such as steel, aluminum or fibers, particularly carbon fiber. These other materials may reduce the cost of manufacturing in particular embodiments or be particularly suitable for “heavier” uses neither of which would sacrafice the versatile utility of the tool. One of the preferred molding substances available in current injection molding process is ABS (Acrylonitrile-Butadiene-Styrene), the specifications of which are available from many sources, but in particular from any good comprehensive polymer handbook, such as Handbook of Plastics, Elastomers, and Composite, 4th Edition, published by McGraw-Hill (2002). ABS has good resistance to impact, hear and chemicals and is a suitable material for injection molding. The dredging tool mold “fork” tentacles (described below) can be formed as to present a favorable strength at eh same time to increase the cycle time of the mold with the minimal effective use of materials.

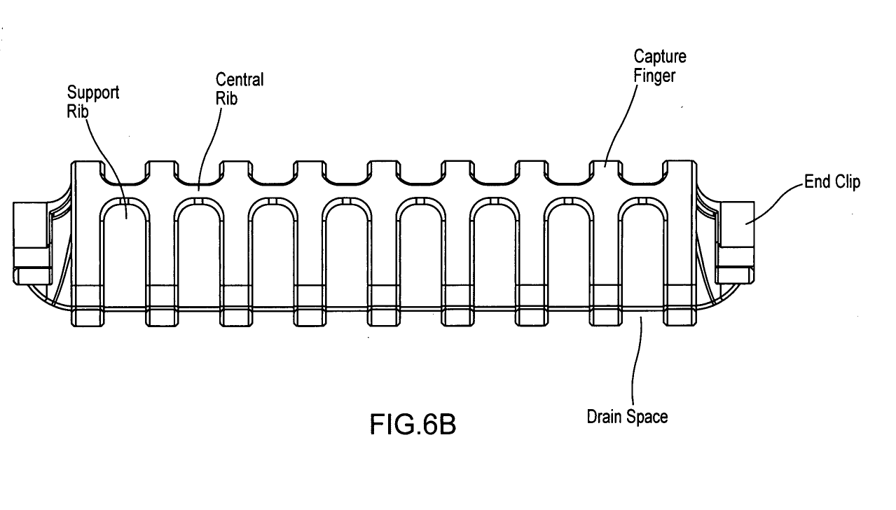

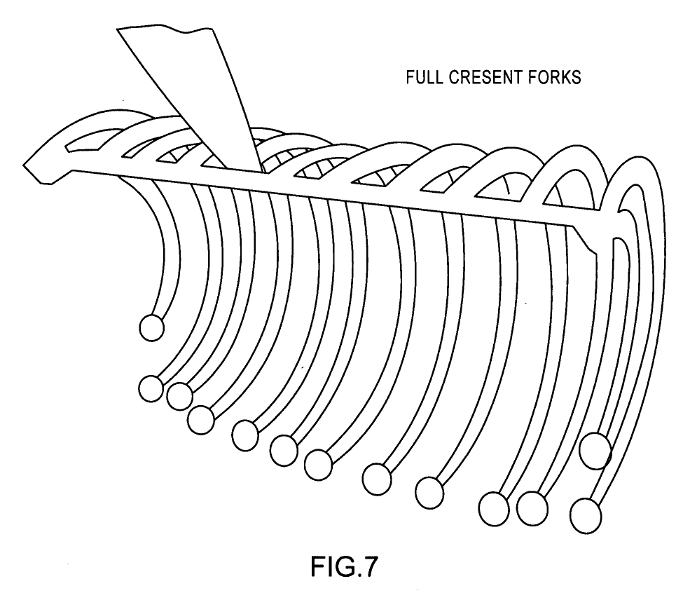

FIGS. 6A and B illustrate generic models of the versatile dredging tool. Note that in the generic tool the fingers in the generic models

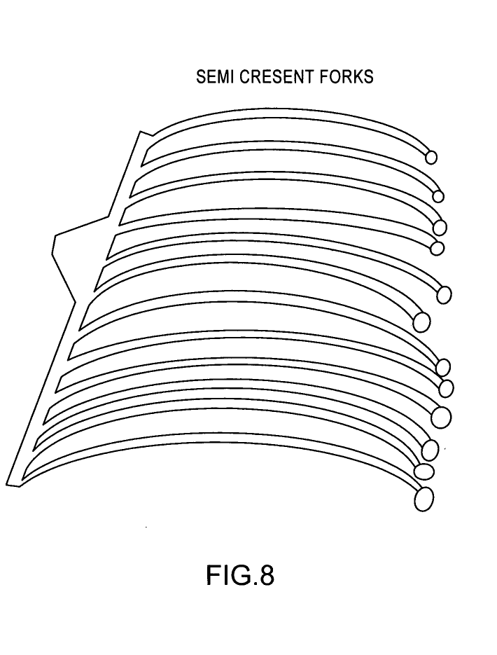

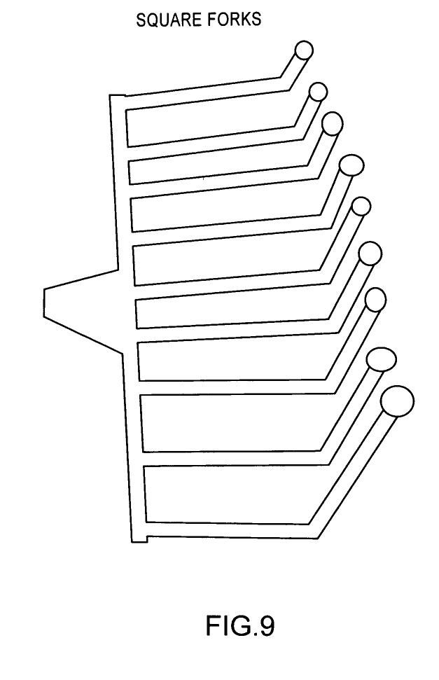

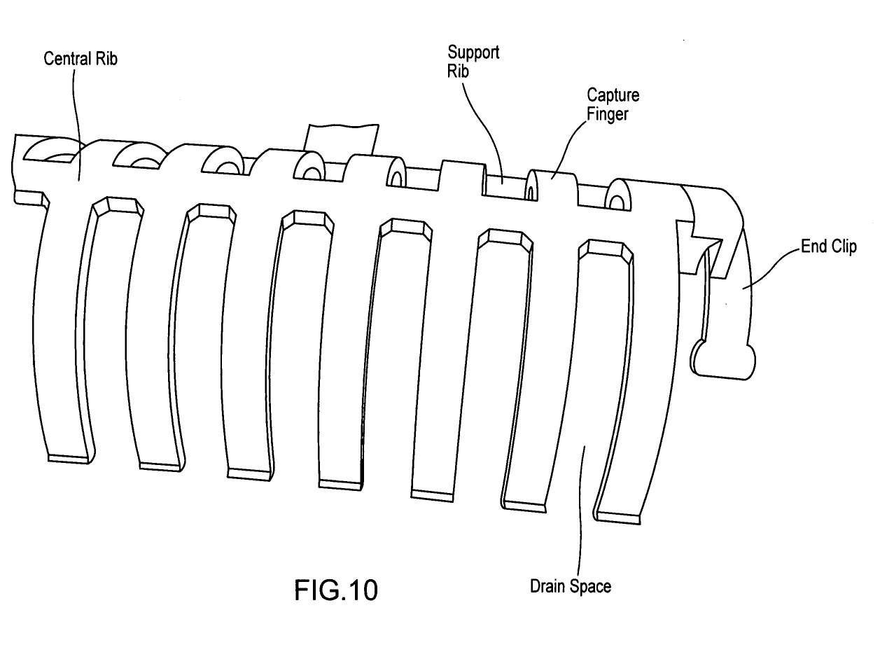

FIG. 7 shows the “full crescent fork” model, which is formed into a crescent-shaped form. This embodiment implements a majority of space between the forks allowing to easily drag through the water and gather leaves. FIG. 8 illustrates the semi-crescent fork embodiment which uses a much wider arc than shown in FIG. 7. FIG. 9 illustrates the square fork embodiment.

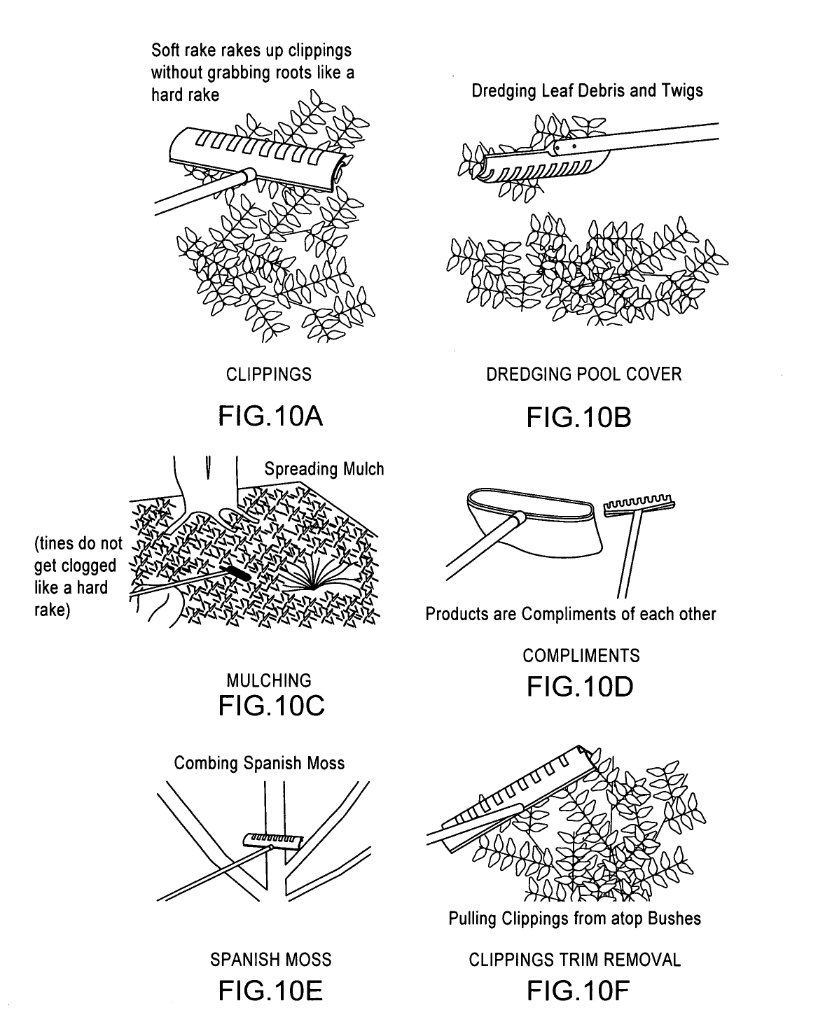

FIGS. 10A-F illustrate other easily identified uses for the versatile tool. The versatile leaf dredging tool is mainly for use in swimming pool, but clearly can be applicable in many home and garden applications, and should not be consider restricted to pool use only. The invention can be used as a soft rake and for cleaning in between plants in a garden. The tool is especially useful in that it does not grab roots just underneath the soil and pull back on the user. The tip of the rake is made not to penetrate the top layer of soil. It is easily maneuvered in between fragile garden plants to clear small twigs and debris out of the area before spreading over mulch. The tool is great for spreading mulch and the prongs or fingers do not get stuck full of mulch like a hard rake. The curved shape of the part allows a user to easily pull mulch and it spread it around plants. The tool also is good for clippings from hedge trimmings and gumball tree seeds and can easily be pulled from atop or underneath bushes/trees after trimming, safe to reach those clippings to remove them instead of standing on a ladder. The tool is convenient and useful for Spanish moss removal, and can be used with an extension pool pole to comb the Spanish moss out of leafy trees with minimal leaf destruction. The tool can also be useful for gutter and drain debris removal. The tool easily catches surface debris without grabbing the soft grassy undergrowth.

Furthermore, the configurations illustrated and discussed are not meant to be restrictive and are for exemplary purposes, and the invention may use different structures, materials, and sizes without departing from the scope of the invention.

1. A plastic-molded pool cover dredging tool comprising: a first portion of a solid uniplanar support panel connected to a second semi-cylindrical portion, said semi-cylindrical portion including a set of fingers extending from a solid horizontal portion formed perpendicular to said uniplanar support panel, said set of fingers first extending downward in a first cylindrical arc, said set of fingers being connected at a second horizontal portion, then said set of fingers extending upward in said first cylindrical arc, each of said finger in said set of fingers terminating in a thicker portion, said tool further comprising two end structures located at each end of said tool, and extending downward from said unipolar support panel in a second cylindrical arc, said second cylindrical arc being smaller than said first cylindrical arc.

2. The dredging tool as recited in claim 1, further comprising a locking tube portion formed into the upper portion of the uniplanar support panel.

3. The dredging tool as reciting claim 2, wherein said locking tube portion includes a set of pre-tensed locking pins.

4. The dredging tool as recited in claim 1, further comprising a structural support molded into each said finger and extending beyond said second horizontal portion in both directions.

5. The dredging tool as recited in claim 4, wherein structure support is arched.

6. The dredging tool as recited in claim 1, wherein said end structures are support by a second uniplanar structured attached to said first cylindrical portion and perpendicular to said first uniplanar structure.

7. The dredging tool as recited in claim 1, wherein said of each of said finger in said set of fingers is approximately the same width as said space between each of said finger.

8-9. (canceled)

10. A versatile home, garden and pool tool for use in removing solid matter from water, including: a molded plastic rake portion, said rake portion including a base and a set of curved structures for debris capture, and a set of drainage spaces in between said curved structures; said curved structures extending from said base; said rake portion including a set of curved end structures, said end structures extending in a arc distinguished from said curved structures; said tool further including a connecting portion, said connecting portion extending the general opposite direction from said curved structures and configured such that it can be fit into a hollow extension rod.

11. The tool as recited in claim 10, further including a set of pre-tension locking pins located inside said connecting portion.

12. The tool as recited in claim 11, further including a rounded structure at the end of each curved structures.

13. The tool as recited in claim 11, wherein the tool is made injection-molded plastic.

14. The tool as recited in claim 13, wherein said molded plastic is ABS.

15. The tool as recited in claim 13, further included support structure located on each of said curved structures.

16. A versatile home, gardening and pool tool with reduced-footprint in a retail setting, said tool injection-plastic molded in a single piece and configured for attachment to an extension pole, said tool including a base plate contained on a single plane, said base plate having a connection tube at one end, said connection tube for fitting into said extension pole, said base plate include a base horizontal member perpendicular to said base plate, said base horizontal member supporting a set of removal fingers, including a set of spaces between each of said set removal fingers, said base horizontal member and said removal fingers being curved, such that when placed in a retail setting, said tool will stack in said curved portion, such that footprint is reduced.
